(19) United States
(12) Patent Application Publication
(10) Pub. No.: US 2008/0082664 A1
(43) Pub. Date: Apr. 3, 2008

(54) RESOURCE SELECTION

(76) Inventors: Valentin Popescu, Houston, TX (US); Thomas J. Flynn, Houston, TX (US); Gary A. Willett, Houston, TX (US); Mark J. Altendorf, Houston, TX (US); Quoc P. Pham, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/537,337

(22) Filed: Sep. 29, 2006

(51) Int. Cl. G06F 15/173

(52) U.S. Cl. 709/226

(57) ABSTRACT

A system comprises a client, a plurality of remote resources, and a gateway. The gateway, on at least the basis of a user of the client or a user group to which the user is a member, selects a remote resource to be used by the client

### BACKGROUND

Some computing environments comprise one or more client computers and multiple resources. A resource may comprise, for example, a server. As the number of clients and resources grows, it becomes cumbersome for a user of a client computer to find and access a desired particular resource

### BRIEF DESCRIPTION OF THE DRAWINGS

For a detailed description of exemplary embodiments of the invention, reference wilt now be made to the accompanying drawings in which:

FIG. 1 shows a system in accordance with illustrative embodiments;

FIG. 2 shows an illustrative embodiment of a computing device usable in the system of FIG. 1;

FIG. 3 illustrates information stored in a gateway usable in the embodiment of FIG. 1;

FIG. 4 shows a method of registering a resource with a gateway in accordance with illustrative embodiments;

FIG. 5 shows additional information stored in the gateway usable in the embodiment of FIG. 1; and

FIG. 6 shows a method of allocating a resource to a client in accordance with illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

FIG. 1 shows a system 10 comprising one or more clients 12, one or more remote resources 20 and a gateway 30. The gateway 30 communicably couples to the clients 12 and resources 20. The clients 12, resources 20, and gateway 30 can be located in close proximity to one another (e.g., in a common datacenter), or may be geographically separated from one another The clients 12 use the various resources 20. The gateway 30 facilitates the allocation of the resources 20 to the clients 12. A user of a client 12 may be a member of a user group. Each user group may contain one or more users as members. A user may be a member of more than one user group. Each user group may have an associated job role. For example, users in the finance department of an organization may be members of a finance user group, while senior management personnel may be members of their own user group. A user may not be a member of any user group, or may be the sole member of a user group.

In at least one embodiment, the allocation of resources 20 by the gateway 30 is based on the job role of the users of the clients. For example, a user that is a member of a “finance” user group is permitted access to certain resources pre-designated for use by members of the finance group. Users of one user group may be permitted access to resources that differ from, or may be the same as, the resources to which members of other user groups are permitted access. In accordance with the embodiments described herein, the gateway 30 is responsible for allocating resources to clients.

Referring still to the embodiment of FIG. 1, each client 12 comprises a computing device such as a computer. As such, each client 12 may comprise a notebook computer, a desktop computer, etc. The gateway 30 also comprises a computer (e.g., a server) in at least some embodiments. Each resource 20 may comprise any type of hardware and/or software resource that would be needed by a client 12. For example, in some embodiments, a resource 20 comprises a computer such as a server. In other embodiments, a resource 20 comprises a virtual machine. In some embodiments, the collection of resources can include different types of entities. That is, some resources may comprise one type of entity, such as a server, while other resources comprise another type of entity, such as a virtual machine.

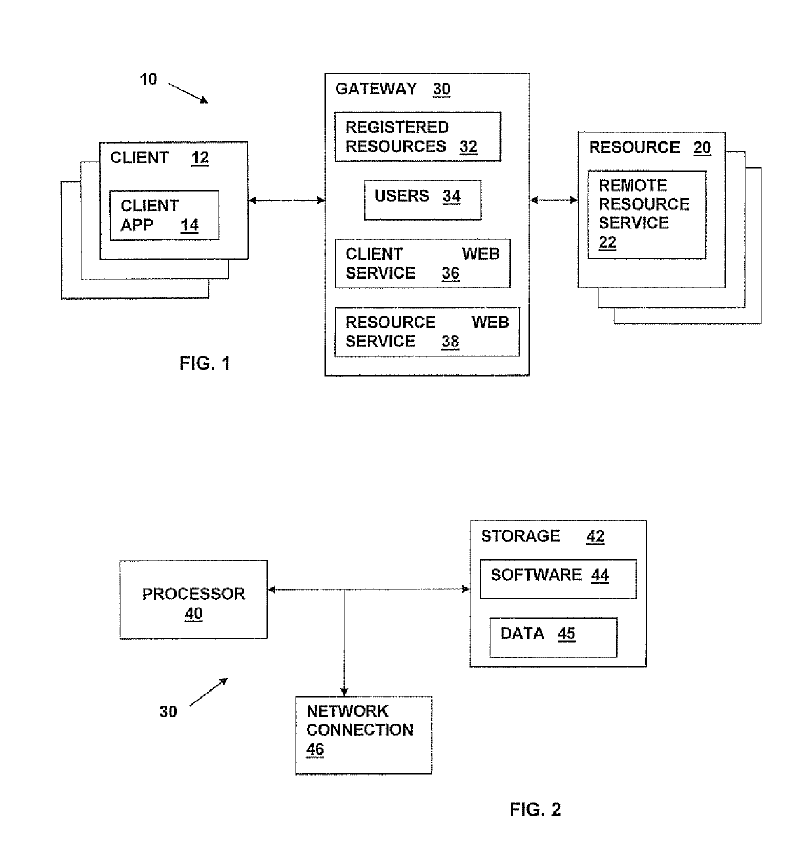

Referring now to FIG. 2, an embodiment of gateway 30 is shown as comprising a processor 40 coupled to storage 42 and a network connection 46. The storage 42 comprises a computer-readable medium such as volatile memory such as random access memory (RAM), non-volatile storage (e.g., hard disk, compact disc read only memory (CD ROM), read only memory (ROM), etc.) and combinations thereof. The network connection 46 enables the gateway 30 to communicate with the clients 12 and the resources 20. The network connection 46 may be a wired connection or a wireless connection.

The storage 42 of the gateway contains software 44 that is adapted to be executed by processor 40. The software 44, when executed by the processor 40, causes the processor 40 to perform various actions described herein that give the gateway some or all of its functionality. The gateway's storage 42 also contains data 45 that is used by the software 44 to perform various tasks.

The architecture of the clients 12 may be the same as, or similar to, the architecture of the gateway 30 depicted in the illustrative embodiment of FIG. 2. A client 12 may also comprise a display. To the extent a resource 20 also comprises a computer, such a resource may also have the same or similar architecture as the gateway 30. In FIG. 1, the gateway comprises executable code 36 and 38. Code 36 comprises a client web service, while code 38 comprises a resource web service. The software 44 of FIG. 2 thus comprises the client web service 36 and the resource web service 38 of the gateway embodiment of FIG. 1. In FIG. 1, clients 12 are shown containing an executable client application 14 and resources 20 are shown comprising an executable remote resource service 22.

FIG. 1 also shows the gateway 30 comprising data structures 32 and 34. Data structure 32 comprises information identifying registered resources and data structure 34 comprises information identifying users. These data structures 32 and 34 are represented in FIG. 2 as data 45.

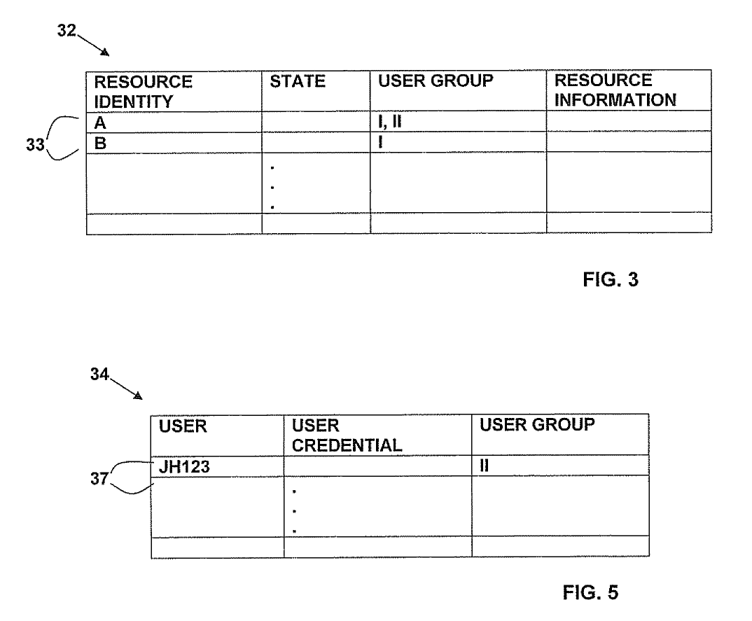

FIG. 3 illustrates an embodiment of the registered resources data structure 32 as stored in the gateway 30. As shown, data structure 32 comprises a plurality of entries 33. Each entry comprises a resource identity, a state of the resource, user group(s) to which the identified resource can be used, and resource-specific information. The identity of the resource 20 may uniquely differentiate the resources from each other. The resource identity may be a serial number assigned to the user by the manufacturer of the resource, an alphanumeric designation assigned by a network administrator, or any other suitable type of identifier.

The state of the resource identifies the current operational state of the associated resource. An exemplary list of states is provided in Table I below.

TABLE I
Resource States

| State | Description |
|---|---|
| On | Resource is powered on |
| Off | Resource is powered off |
| Becoming on-line | The resource is transitioning to a state |
| | in which the resource can be allocated |
| | to a client |
| Going off-line | The resource is transitioning to a state |
| | in which the resource will not be usable |
| | to allocate to a client |
| User logged off | A user of client has logged off of the |
| | resource, resource now available to be |
| | assigned to a client |
| User disconnected | User of client has disconnected |
| from resource | communication with the resource, but |
| | resource still assigned to the user and |
| | may be still be processing data on |
| | behalf of user |
| Property change | Resource has reported a change to |
| | one or more of its properties |

Each resource 20 can be allocated for use by a client user that is a member of one or more selected user groups. For example, resource A in FIG. 3 can be used by users that are members of user groups I and II, while resource B can only be used by users that are members of user group I.

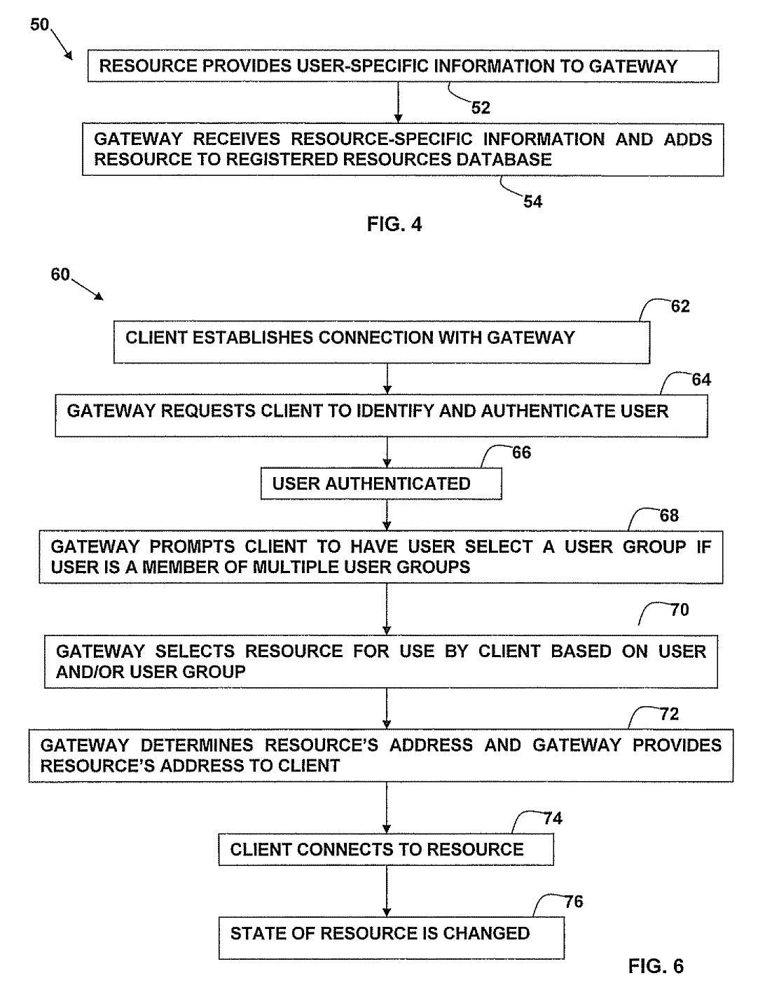

FIG. 4 shows an illustrative method 50 by which a resource 20 registers with the gateway 30. The registration process is performed so that the gateway 30 can be informed of the existence of the resource so that the gateway can assign the registered resource, in an appropriate situation, to a client. At 52, the registration method 50 comprises the resource 20 providing information specific to that resource to the gateway 30. The information may include any, or all, of the following information
Hardware description
Address or range of addresses (e.g., medium access control (MAC) address and/or transmission control protocol/internet protocol (TCP/IP) address, etc.)
Physical location (erg., slot in a rack in which resource is installed)
Serial number and asset tag
   Some, or all, of the aforementioned information may be transmitted from the resource 20 to the gateway 30 each time the resource provides a message to the gateway updating the resource's status. Some, or all, of the information listed above may be included in the resource information field of the registered resources data structure 32. At 54, method 50 comprises the gateway 30 receiving the resource-specific information and adding information regarding the resource to the registered resources database 32.

FIG. 5 illustrates an embodiment of the users data structure 34 as stored in the gateway 30. As shown, data structure 34 comprises a plurality of entries 37. Each entry comprises an identity of a user, that user's authentication credentials, and one or more user groups, if any, to which that user is a member. For example, user JH123 is a member of user group II. The designation of a resource to a particular user group can be made automatically by the gateway 30 in accordance with a suitable set of rules or by a person (e.g., a network administrator).

The user credential is used to authenticate the user of the client 12. Accordingly, the credential may comprise a password, a fingerprint template or any other suitable value by which the user can be authenticated. In some embodiments, in addition to the user's identity and/or user group, the gateway 30 determines which resource to assign to the user's client 12 based on the user's credential. Thus, a particular client 12 may be assigned to some resources when a first user uses the client, but to a different set of resources if a different user uses the same client 12. The credential is used in at least some embodiments to differentiate one user from another.

FIG. 6 illustrates a method 60 which a resource 20 is selected by the gateway 30 for use by a user of a client 12. The actions attributed herein to being performed by the client 12 are performed by the client application 14 (FIG. 1) that executes on the client 12. The actions attributed to being performed by the gateway 30 as it interacts with the client 12 are performed by the gateway's client web service 36.

At 62, the client 12 establishes communication with the gateway 30. This act can be performed, for example, by a user of the client executing the client application 14 (FIG. 1). The client application 14 submits a request to the gateway 30 for a resource to be allocated for use by the client on behalf of the user. At 64, the gateway requests the client 12 to identify and authenticate the user. This act can be performed, for example, by the client 12 prompting the user to enter an identifier of the user and a password. At 66, the user is authenticated by, for example, verifying that the use provided a valid password. The client authentication can be performed by the client 12 or the gateway 30.

At this point, the gateway 30 has identified the user by, for example, the user's identifier and/or credential. By examining users data structure 34, the gateway determines whether the user is a member of more than one user group. If the user is a member of more than one user group, then at 68, the gateway 30 causes the client 12 to prompt the user to select one of the user groups to which the user is a member. In some embodiments, the user is provided with a menu of user groups from which the user selects.

At 70, the gateway, having been informed by the client 12 as to the user group for the user, selects a resource for use by the client based, in at least some embodiments, on the user's identity and/or the user's user group. The registered resources data structure 32 (FIG. 3) specifies the user groups to which each resource can be used. The gateway 30 decides the resource to use by, for example, consulting the registered resources data structure 32 to determine which resources can be used for the specified user group.

In other embodiments, the selection by the gateway 30 of a resource may also be based on the states of the various resources. For example, a resource that is not currently being used by a user will be given priority over a resource that is already in use.

In still other embodiments, the gateway 30 takes into account the user's credential when selecting a resource to allocate to a particular user, For example, a member of a given user group may be assigned a special password that gives that user the rights to access resources beyond the resources otherwise designated for use by that user's user group.

At 72, the gateway 30 determines the address of the selected resource 30 from the resource information field of the registered resources data structure 32. The gateway 30 then provides the address of the selected resource 30 to the client 12. At 74, the client 12 uses the address to operatively connect to the resource 30. At 76, the gateway 30 changes the state of the resource in the registered resources data structure 32 to reflect that the resource has been assigned to a user. The operative connection between the client 12 and the resource 30 need not include the gateway 30. That is, in at least some embodiments, data transmissions between client 12 and resource 20 do not flow through the gateway.

The embodiments described herein relieves a user of a client 12 from having to determine the address of a desired resource. Instead, that burden falls on the gateway 30.

Some embodiments comprise multiple gateways 30. Each such gateway 30 comprises a client web service 36 and a resource web service 38 and each such gateway 30 accesses, in some embodiments, a common database containing the registered resources 32 and users 34. When a client 12 attempts to establish a connection with a gateway to obtain access to a resource, the client 12 is automatically connected to one of the available gateways. If the connection between the client 12 and the gateway is slow, the client 12 can disconnect from that gateway and select, via, for example, a graphical user interface, a different gateway, or may simply request another gateway 30 to be used (selected automatically for the client).

In some embodiments, the gateway 30 enforces a “policy” for each session. A policy comprises at least one parameter regarding a screen appearance. A policy may comprise, for example, the colors that are used on a display of the client 12, the screen size of a window on the client's display, etc. The policy of one user group may be the same as or different from the policy of another user group. Accordingly, the gateway may enforce multiple policies. The policies may be enforced at the user group level, or for individual users.

In some embodiments, the connection between the client 12 and the resource 20 may become inoperative. Upon the client 12 attempting to re-establish the connection, the gateway 30 detects that the same user (same user detectable using the users credentials) is attempting to re-connect The gateway 30 facilitates re-establishing the connection between the client 12 and the same resource 20 on behalf of the client 12.

In some embodiments, a user may attempt to connect to the gateway from a different client 12 than the user has already used to connect to a resource 20. For example, the gateway 30 may have already facilitated assigning a particular resource to a user who accessed the gateway from that user's home computer (client). With that client-resource connection active, the user may then attempt to connect to the gateway 30 via the user's work-place computer. The user will again present his or her credential (e.g., password) to the gateway 30. On the basis of the credential, the gateway 30 determines that the user is the same user already assigned a resource. In some embodiments, the gateway redirects the connection from the user's home computer to the user's work-place computer so that the user will be connected to the resource via the work-place computer.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a client;
a plurality of remote resources; and
a gateway coupled to said client and said remote resources, said gateway, on at least the basis of a user of said client or a user group to which the user is a member, selects a remote resource to be used by the client.

2. The system of claim 1 wherein said gateway selects a remote resource also on the basis of states of said remote resources.

3. The system of claim 1 wherein said gateway contains information pertaining to said remote resources, said information identifying each remote resource and, for each such remote resource, a state of said remote resource and user or a user group to which such remote resource can be allocated.

4. The system of claim 1 wherein said gateway contains information pertaining to a plurality of users wherein, for each user, said information identifies one or more user groups to which such user corresponds.

5. The system of claim 1 wherein said gateway contains information pertaining to a plurality of users and, for each user, said information comprises a user credential.

6. The system of claim 5 wherein said gateway selects a remote resource also on the basis of said user credential.

7. The system of claim 1 wherein said gateway contains information pertaining to a plurality of users and, for each user, said information comprises a user credential and an identification of one or more user groups to which such user corresponds

8. The system of claim 1 wherein said user group corresponds to a job role.

9. The system of claim 1 wherein said remote resources comprise resources selected from a group consisting of computers and virtual machines.

10. The system of claim 1 further comprising a plurality of gateways, each gateway operable to select a remote resource to be used by the client.

11. The system of claim 1 wherein said gateway enforces a plurality of policies, each policy comprising at least one parameter regarding a screen appearance.

12. The system of claim 11 further comprising multiple user groups and wherein different policies apply to different user groups or different users.

13. The system of claim 1 wherein a first client uses the resource, and wherein the gateway causes a second client of said user, to reconnect to the same.

14. The system of claim 1 wherein, if a connection between said client and said selected resources become inoperative, said gateway causes the client to reconnect to said resource.

15. The system of claim 14 wherein the gateway causes the client to reconnect based, in part, on a user credential.

16. A computer-readable medium containing software that, when executed by a processor, causes the processor to:
receive an identifier of a user of a client computer or a user group to which said user is a member; and
determine, on the basis of the identifier of the user or the user group, a resource to allocate for use by said client computer.

17. The computer-readable medium of claim 16 wherein said software causes the processor to provide an address of said determined resource to said client computer.

18. The computer-readable medium of claim 16 wherein said software causes the processor to access information pertaining to said remote resources, said information identifying each remote resource and, for each such remote resource, a state of said remote resource and the user or a user group to which such remote resource can be allocated.

19. The computer-readable medium of claim 16 wherein said software causes the processor to access information pertaining to a plurality of users wherein, for each user, said information identifies one or more user groups to which such user corresponds.

20. The computer-readable medium of claim 16 wherein said software causes the processor to access information pertaining to a plurality of users and, for each user, said information comprises a user credential.

21. The computer-readable medium of claim 16 wherein said software causes the processor to access information pertaining to a plurality of users and, for each user, said information comprises a user credential and an identification of one or more user groups to which such user corresponds.

22. A method, comprising:
receiving a request from a client computer; and
determining, on the basis of an identifier of a user of the client computer or a user group to which said user is a member, a resource to allocate, by a gateway computer, for use by said client computer.

23. The method of claim 22 wherein determining a resource to allocate comprises determining a resource to allocate also on the basis of states of said remote resources.

24. The method of claim 22 wherein determining a resource to allocate comprises determining a resource to allocate also on the basis of a user credential associated with said user.

25. The method of claim 22 wherein determining a resource to allocate comprises determining a resource to allocate also on the basis of a user credential and one or more user groups of which such user is a member

26. The method of claim 22 further comprising registering a resource.
